(19) United States
(12) Patent Application Publication
(10) Pub. No.: US 2015/0017360 A1
(43) Pub. Date: Jan. 15, 2015

(54) INSULATED COMPONENT OF A HOUSEHOLD APPLIANCE, IN PARTICULAR OF A DISHWASHER, AND METHOD FOR MANUFACTURING SUCH A COMPONENT

(71) Applicant: ELECTROLUX HOME PRODUCTS CORPORATION N.V., Brussels (BE)

(72) Inventors: Andreas Krupicka, Porcia (IT); Carlo Tomaselli, Porcia (IT); Carlo Urbanet, Porcia (IT); Corrado Cecchini, Porcia (IT); Massimo Sanita', Porcia (IT)

(73) Assignee: ELECTROLUX HOME PRODUCTS CORPORATION N.V., Brussels (BE)

(21) Appl. No.: 14/375,313

(22) PCT Filed: Feb. 8, 2013
(86) PCT No.: PCT/EP2013/052522

§ 371 Date: Jul. 29, 2014

(30) Foreign Application Priority Data
Feb. 9, 2012 (EP) 12154719.4

(51) Int. Cl. A47L 15/42; G10K 11/168

(52) U.S. Cl. CPC A47L 15/4255; A47L 15/4246; G10K 11/168
USPC 428/35.7; 428/423.1; 428/339; 428/318.6; 428/218; 427/427.4

(57) ABSTRACT

An insulated component (1) of a household appliance, in particular of a dishwasher, comprising a substrate (10) and an insulation structure (12) applied onto a surface (13) of the substrate (10); wherein the insulation structure (12) comprises one or more layers (14) made of one or more sprayable filled polyurethane materials, wherein said one or more layers (14) comprise a layer (14a, 14d) made of elastomeric polyurethane material applied directly onto the surface (13) of the component (1) and having the following properties:
a specific density comprised between 1 and 3 g/cm³;
a tan delta at 20° C. and at 100-300 Hz comprised between about 0.4 and 1.6; and
a tan delta at 60° C. and at 100-300 Hz comprised between about 0.5 and 2.2.

The present invention relates to an insulated component of a household appliance, in particular of a dishwasher, a method for manufacturing such a component, and to a household appliance comprising such a component.

The invention is particularly intended to provide insulated components of a dishwasher such as steel and plastic tub/housing/washing chamber, steel and plastic innerdoor, base and plinth (lower door), parts thereof.

It is well known that dishwasher machines have some parts that require to be insulated in order to dampen noise and vibrations.

A common material used to insulate inner component parts of a dishwasher, such as tubs, innerdoors, plinths, etc., is bitumen, possibly associated with absorption felts.

Bitumen applied directly onto the dishwasher structure has the purpose to dampen noise and vibrations, as well as to control thermal and energy flows and sometimes to add weight to the structure. Felt layers are mainly used for noise absorption purposes.

Bitumen is currently the common material solution applied to dishwashers having steel tubs, but it is also frequently applied to dishwasher plastic tubs. Actually, bitumen is considered the most suitable insulation material for dishwashers because it has the best performance-to-cost ratio. In fact, bitumen has a semi-fluid behaviour, especially at high temperature, and accordingly has mainly a viscous response that makes this material highly suitable for damping/deadening purposes. Bitumen is also suitable to be heavily filled (for example with mineral/metal oxides fillers).

From the other hand, use of bitumen materials is subject to the risk of emissions, in case of heat exposure, of volatile organic compound associated with the presence in the material of polycyclic aromatic hydrocarbons and sulphured compounds (even if in very small amount).

It has been also discovered by the Applicant that common commercially bitumen foil formulations offered for noise and dampening applications do not sufficiently dampen critical vibration frequencies in the whole dishwasher operational range of service temperatures, especially in the “cold” condition, due to the viscous-elastic characteristics of bitumen organic composition (based predominantly on crude oil). In particular, there is a great difference in damping performance in “cold” and “hot” conditions: for example, in a traditional dishwasher structure, acoustical tests have revealed that the noise difference between “cold” and “hot” conditions corresponds to at least 1 dB, which is a significant value. This problem cannot be overcome since the dampening mechanism of bitumen is mainly ensured by vicinity to the material phase transition from solid state to molten fluid: for improving the material response to relatively low temperature, the material would substantially be a molten fluid, and not a solid component material, and would not be practically usable.

Furthermore, bitumen damping properties are subject to undesirable ageing.

A material property commonly used in the context of damping performance, and which will be widely used in the context of the present invention, is the “loss factor”, or “tan delta”, according to ISO 6721. “Loss factor” or “tan delta” is the ratio between the loss modulus and the storage modulus where “delta” is the phase angle between stress and strain. The two terms “loss factor” and “tan delta” will be indistinctly used in the rest of the description.

The loss factor, expressed as a dimensionless number, is commonly used as a measure of the damping in a viscoelastic system. The loss factor values that will be given for the layer specifications of the present invention refer to the shear test method (where applicable, as described in ISO 6721-6), flexural test method (where applicable, as described in ISO 6721-5) or torsion test method (where applicable, as described in ISO 6721-7).

Plastics and elastomers generally offer high damping for the combination of temperature and frequency where their molecular transitions occur. In fact, according to ASTM D4065, the transition temperatures of a plastic material are determined from the peak values of the loss factor (i.e. tan delta, also sometimes referred to as “loss tangent”) plotted against temperature. For the purposes of the present invention, the transition temperature is the temperature at which the loss factor is maximum, when plotted as a function of temperature following a ISO6721-7 single frequency test at 1 Hz and 2°/min heating rate in the temperature range of −90 to 110° C. (at a dynamical strain that does not exceed the limit for linear behaviour, i.e. the linear viscoelastic strain limit, as defined later in this text).

Use of bitumen has also other drawbacks, mentioned below.

From a manufacturing process point of view, a very common steel tub structure consists of different components, each requiring a specific manufacturing process: formed steel sheets (for top, side-wrap and base), cut-to-size deadening/insulation layer (bitumen foil) and cut-to-size sound absorption sheet (cotton felt). The manufacturing process of an insulated tub is therefore relatively long and complicated.

Use of bitumen also has disadvantages from the environmental impact viewpoint. In particular, high energy consumption is required, in terms of heat provided by large furnaces, for applying bitumen deadening foils to the steel sheets of the tub structure. This is also a negative factor for handling and cycle time.

An issue also related to environmental impact is the extra energy that is frequently needed to remove bitumen from the steel structure after the dishwasher has finished its service (and the valuable stainless steel has to be recovered and recycled). This is due to the fact that bitumen adhesion to steel is higher than its cohesion strength. Even if modern recycling station can effectively remove bitumen from steel sheets, nevertheless the operation remain expensive.

Felts generally have the advantage to be available in a large variety of forms and compositions, so as to be tailored to provide a wide range of performances satisfying most specifications.

As previously mentioned, in today's dishwasher production, felts are applied over the bitumen substrate to constitute the absorption layer. Felts have however also some disadvantages.

First of all, it is difficult to produce, at reasonable costs, felts offering high values of fire resistance. Moreover, also due to their physical form and composition, it is very difficult to manufacture felt sheets having identical characteristics. Some felts also contain chemical substances that during dishwasher operations could produce formaldehyde emissions. Furthermore, due to the fact that felts are made of loose fibres having limited cohesion, there is a risk in transportation, handling, installation and service life that some fibers get lost and contact some adjacent electronic components, creating fire hazard. Finally, due to bitumen surface characteristics and the physical form of felts, the only way to fix the felts to the bitumen substrate is to physically/mechanically clamp the felts between the tub (or other part of the dishwasher, such as the inner-door) and the outer steel structure. However, this kind of fastening method is not fully effective and reliable and long-lasting.

Other known solutions for providing dampening and thermally insulating structures make use of plastic insulation layers, produced by extrusion or moulding (polyurethane technology, polystyrene technology, polyolefin technology, etc.). All these solutions have to be applied either as layers by chemical bonding, or by advanced moulding techniques, and for this reason they either do not provide additional performance advantages or become impractical and/or expensive for dishwasher manufacturing.

For example, a known insulation material is polyurethane, commonly used in the automotive and building structures fields. In the field of home and professional electric appliances, polyurethane is currently the thermal insulation solution for refrigeration appliances. The common process to apply polyurethane to complex steel and plastic structures is reaction injection moulding (RIM). A more recent evolution of polyurethane technology is the development of process equipments and procedures that allow spray application of high-solid polyurethane compositions to form continuous layers in the millimetre thickness range by using high-solid resin (i.e. resin not dispersed in solvents).

U.S. Pat. No. 3,501,564 discloses how to produce hybrid multilayers including polyurethane material using interbonding adhesives. U.S. Pat. No. 5,856,371 discloses a method for producing a multilayer sandwich comprising both dense polyurethane and foamed polyurethane, in particular for the production of bath tubes. Both these patents describe polyurethane technologies that allow the formation of thick mono-layers, like for instance flexible dense insulation layers (made of flexible to semi-rigid polyurethane compositions with or without fillers) or porous foamed layers.

Improvements have been developed for making spraying technology of high-viscous high-solid polyurethane possible (WO2010101689), as well as for combining the tailor-ability of polyurethane material technology and high-solid polyurethane spray application in order to solve specific application problems (JP6343567, WO2008012247).

Use of polyurethane as insulation material in the field of electric appliances is mentioned in DE10118632, EP1522250, US2003175491, DE4110292, GB1244522.

In particular, DE10118632 discloses a noise and heat insulated wash chamber for a dishwasher provided, on the outer surfaces of the walls and possibly the door, with a non foamed insulating polyurethane material. However, DE10118632 and the other prior art documents fail to disclose highly-viscous resins applied by spray technology (specifically, no prior art document discloses the use of polyol resin containing filler and supplied to a spray head where the resin is mixed/applied together with the isocyanate as advantageous solution for electric appliances or as solution to specific dishwasher problems solved by the present innovation).

Moreover, neither DE10118632 nor any other cited document specifically considers the vibrational damping behaviour of polyurethane materials in “cold” conditions.

WO2011086076 discloses a method for applying a polyurethane foam coating on appliances, with the purpose to replace common two-layer bitumen-felt solutions (consisting of a bitumen filled dense layer and a felt porous layer) with polyurethane foamed porous layers (possibly with an outermost solid elastomeric skin).

The Applicant has found that the teaching of WO2011086076 shows several drawbacks. First of all, this method substantially teaches to reduce mass and heat capacity of traditional system. However, in such a way also the dampening insulation (in terms of surface density) is reduced. Moreover, the insulation coatings do not contribute to improve the structural stiffening of the dishwasher structure.

From the information provided in WO2011086076 it is also evident that non-filled polyurethane formulations are used, resulting in an economically not feasible replacement for bitumen and felt constructions. The solution also require pre-cleaning step of the steel substrate (involving water consumption and an environmental impact) since the layered foam solutions constitute a weak interface to steel contaminated with greasy water emulsions reacting with isocyanate intensifying foam in interface. The adhesion to substrate is likely to be further weakened by the absence of filler to reduce polyurethane reaction shrinkage and to reduce the polyurethane thermal expansion during washing in normal service. Furthermore a foam interface will not give the tub manufacturing benefit of watertight tub assembly allowing complexity reduction in terms of eliminating the need for applying sealer in tub lining.

Moreover, the Applicant has determined that a solution based on the use of a foam like the one disclosed in WO2011086076, i.e. having a damping factor of at least 0.2 measured at 1 Hz and at a temperature ramp rate of 5° C./min from 40° C. to 60° C. as determined according to ASTM D 4065 (with glass transition temperature from 30° C. to 60° C.), is an equivalent of the common materials present in dishwasher, like bitumen and felts, and subsequently fails to ensure improved performance compared to these materials. This observation is confirmed by thermal-acoustical dishwasher performance data presented in WO2011086076. These performances compare well with those of a dishwasher insulated with less amount of common materials having consequently reduced energy consumption but compromised acoustics. Specifically, like all other cited prior art documents, WO2011086076 is not likely to provide vibrational damping improvement, in particular at “cold” dishwasher conditions.

In conclusion, current dishwasher structures (in particular, tub and door structures) are insulated in order to reduce vibrations and noise by adding mass and absorption materials. Generally speaking, the result is achieved by adding more bitumen mass to the structure (by increasing bitumen compositional density and/or increasing bitumen thickness) and by adding more absorption felt. Dishwasher structures can be prepared in this fashion to perform satisfactory with respect to the current dishwasher best-in-class acoustic/vibration performance specifications.

An increasing trend is that dishwasher structures are also specifically insulated to reduce energy consumption. In this regards, the common approach to save energy is to reduce bitumen mass on the structure. Dishwasher structures can be prepared in this fashion to perform satisfactory with respect to the current dishwasher best-in-class energy performance.

Clearly, the two aspects (vibration/sound reduction and energy saving) call for opposite solutions. Current design approach requires therefore to optimize one aspect and to compromise the other.

Moreover, today's dishwasher insulated tub manufacturing methods are generally energy-consuming and complicated, thus limiting product insulation differentiation (i.e. the number of product variations in terms of acoustical and energy declarations) and cost-efficiency changes in tub structure design and thickness.

It is therefore an object of the present invention to provide a method for manufacturing an insulated component of a household appliance, in particular of a dishwasher, a household appliance insulated component obtained by such a method, and a household appliance containing such component, designed to eliminate the aforementioned drawbacks.

In particular, it is an object of the invention to provide a manufacturing method, a component, and a household appliance that allow best-in-class performances to be obtained from both the acoustics/vibrations and the thermal point of view.

According to the present invention, there is provided a method for manufacturing an insulated component of a household appliance, in particular of a dishwasher, comprising the steps of:
providing a substrate defining a base body of the component;
applying by a spray process an insulation structure onto the surface of the component, the insulation structure comprising one or more layers applied by respective spraying steps and being made of one or more sprayable filled polyurethane materials, wherein said one or more layers comprise a first layer made of elastomeric polyurethane material applied directly onto the surface of the component and having the following properties:
a specific density comprised between about 1 and 3 g/cm³;
a tan delta at 20° C. and at 100-300 Hz comprised between about 0.4 and 1.6; and
a tan delta at 60° C. and at 100-300 Hz comprised between about 0.5 and 2.2.

The present invention also relates to an insulated component of a household appliance, in particular of a dishwasher, manufactured by the method previously described.

In particular, an insulated component according to the present invention comprises a substrate and an insulation structure applied onto a surface of the substrate, the insulation structure comprising one or more layers made of one or more sprayable filled polyurethane materials, in particular a first layer made of elastomeric polyurethane material applied directly onto the surface of the component and having the following properties:
a specific density comprised between about 1 and 3 g/cm³;
a tan delta at 20° C. and at 100-300 Hz comprised between about 0.4 and 1.6;

and
a tan delta at 60° C. and at 100-300 Hz comprised between about 0.5 and 2.2.

The invention also relates to a household appliance, in particular a dishwasher, comprising such an insulated component.

Said first layer preferably has a tan delta at 20° C. and at 100-300 Hz comprised between about 0.6 and 1.6.

Moreover, the first layer preferably has a tan delta at 60° C. and at 100-300 Hz comprised between about 0.8 and 2.2.

Said first layer has a surface density preferably comprised between about 0.2 and 21 kg/m², more preferably comprised between about 0.5 and 10 kg/m².

Moreover, said first layer has a thickness preferably comprised between about 0.2 and 7 mm, more preferably comprised between about 0.5 and 4 mm.

The specific density of the first layer is preferably comprised between about 1 and 2.5 g/cm³.

Said first layer also has a specific heat capacity at 30° C. preferably comprised between about 0.5 and 2.4 J/gK, more preferably between about 0.6 and 2.3 J/gK.

In one possible embodiment, the insulation structure consists of only one layer, formed by said first layer.

In another possible embodiment, the insulation structure further comprises a second layer made of porous foamed polyurethane material applied onto said first layer.

In particular, the insulation structure may comprise only two layers, being constituted by said first and second layers.

Alternatively, the insulation structure may comprise also a third layer made of polyurethane material applied onto the second layer and having a specific density comprised between about 1 and 3 g/cm³.

In one possible embodiment, the insulation structure is a three-layer structure consisting of said first, second and third layers.

The first layer preferably has a density and/or a thickness lower than the third layer.

Said insulated component may be one of a dishwasher tub, housing, washing chamber, door, base, plinth, or parts thereof.

Moreover, the component may comprise different parts and the method may comprise, before the step of applying by the spray process the insulation structure onto the surface of the component, the steps of providing the parts of the component and assembling the different parts to form the component.

Preferably, the sprayable filled polyurethane materials contain fillers like calcium carbonate (chalk), barium sulfate (barite), talc, quartz silica, other silicates, other oxides (such as iron oxides), hydro oxides, hollow glass spheres, organic fillers. More preferably, the sprayable filled polyurethane materials contain fillers like calcium carbonate or barium sulfate (or iron oxide, in the case of the porous foamed polyurethane material layers).

Moreover, the properties of the first layer, and/or those of the other possible layers, may vary along a direction perpendicular to the surface of the substrate.

The Applicant has found that by providing an insulation structure comprising such a first layer with a tan delta within the above mentioned ranges, the thermal and acoustical performances are improved with respect to the known solutions, since the noise due to vibrations of the panels is very efficiently damped with less thermal mass by the viscous damping property of the layers of the insulation structure.

The particular choice of the temperatures 20 to 60° C. and the frequencies 100 to 300 Hz is due to following:
the temperature range 20 to 60° C. covers the most used temperatures of the dishwasher operation cycle;
the frequency range 100 to 300 Hz is the range that the Applicant found to be of most significant importance to the dishwasher vibration damping. Frequencies lower than 100 Hz are considered of less importance for the dishwasher appliance application (as explained also in IEC6704-1) and generally less perceived by human ears. On the other hand, noise generated at frequencies higher than 300 Hz can be effectively approached and reduced by other properties like surface mass and noise absorption (as outlined later on in the description of the invention). Some of the most critical noise peaks generated by dishwasher electrical motors and water splashing are positioned in the frequency range 100 to 300 Hz.

Basically, the method of the present invention is based on high-pressure spray technology of filled polyurethane materials, that are applied, in different compositions and various layer configurations (in particular, alternating elastomeric dense polyurethane layers and porous polyurethane layers), onto a dishwasher component, in particular a dishwasher tub or door or plinth, after the component has been assembled.

In this way, the traditional multitude of deadening (foils) and absorption (felt) sheet components, sealing materials and adhesive materials, is reduced to the use of just polyurethane and filler raw materials, for producing foam and elastomeric dense polyurethane layers applied in different configurations (different coverage of the component surface, layers arrangement, layers thickness and thickness distribution).

The method of the present invention has several advantages when compared with insulation solution based on bitumen coatings and felt layers.

First, the method of the invention is simpler, faster and more effective; in particular, according to the invention the insulation coating is applied by spray over the complete structure after assembly. Differently, current dishwasher tub and door manufacturing methods require bitumen to be applied on substantially flat steel sheets to minimize process thermal energy and time associated with bitumen application; then the top, wrap and bottom steel sheets of the tub, having the bitumen applied thereon, are assembled into the tub shape. In addition, factory material sourcing and production logistics can be improved by greatly reducing the number of variations given by the use of bitumen foils and absorption felts.

Bitumen acoustical performance setbacks for “cold” phases in the dishwasher cycle is overcome, as well as any quality concerns about chemical compliance and life-time, ageing, stability, adhesion.

While current manufacturing methods cannot provide a complete deadening and adsorption layer coverage of the component, specifically over the sides and corners of the tub, the present invention allows any portion of the component to be coated and hence properly insulated, since the insulation coating is applied by spray technology that can reach any portion of the component. An insulation coating that covers completely the component substrate further enhances the component (for example, the tub) rigidity, strength and noise insulation.

Furthermore, application with spray technology using robotized spray gun allows greatly optimized layer construction and thickness.

The robotized spray also offers the possibility to vary both layer thickness and construction upon identified need over various areas of the tub. Furthermore, the robotized spray application allows practically infinite variations with respect to noise package each layer thickness and construction.

From the performance viewpoint, the invention provides a component that has improved deadening material properties and also improved heat stability and ageing.

In particular, polyurethane deadening material properties that results in comparable performance to bitumen have been identified in terms of dampening performance as measured by loss factor (higher loss factor—higher damping). Polyurethane formulations can be tailored to perform comparable in terms of loss factor at hot and significantly better at cold, compared to bitumen. In addition, if a polyurethane multi-layer structure, that contains two or more layers, is used, each layer formula can be selected to provide different frequency-temperature positioning of glassy to rubbery material phase transition that for polyurethane is the material mechanism providing good dampening in terms of high loss factor value. By this approach, the inherent material drawback of bitumen to limit good dampening only in the higher temperature region in the appliance operative temperature range is overcome.

Furthermore, bitumen, being soft at room temperature and becoming a semi-fluid (and therefore very soft) at increased temperatures, cannot be combined with felt layers in a way that creates a stiffening sandwich effect. Instead, a polyurethane sandwich made according to the invention, where a dense polyurethane layer is applied thick and does not soften dramatically with temperature and adheres to a foamed polyurethane layer, results in a sandwich having superior stiffness.

Felt inherent issues with adhesion are also overcome.

In addition post-life disassembly is facilitated.

The method of the invention also has advantages with respect to known polyurethane insulation systems.

In fact, known layer constructions using un-filled polyurethane and/or polyurethane foam (disclosed by the above cited patent documents), are not actually fully satisfactory, besides being expensive, mainly because of a poor adhesion to the steel substrate which reduces the effective structural vibration damping (the adhesion also decreasing radically over time with the number of dishwasher cycles, due to significant thermal mismatch between the non-filled polyurethane layer and the adjacent substrate, in case of steel substrate). Un-filled polyurethane and/or polyurethane foam exhibits excessive sensitivity to common steel sheet contaminations such as fatty water emulsions, unless steel pretreatment steps are introduced in the manufacturing production line, that results in higher cost (raw material consumption, longer cycle-time, investment write-off) and environment problem (water consumption, energy consumption).

Moreover layer constructions using, in direct contact to substrate, un-filled polyurethane (foam or non-foam) are not preferred for thermal performances. The reason for this is that polyurethane exhibits high specific heat capacity (more than 1.5 times higher than filled polyurethane). Structures with high heat capacity have been found to not be able to reach best in class dishwasher thermal performance. Consequently, the solution of the present invention using filled polyurethane material overcomes this weak point.

Porous materials like foams applied directly to vibrating panels that are emitting noise, as the dishwasher substrates, are less effective in conveying the damping properties of the material (defined by tan delta) to the panels. Consequently, a foam layer application to dishwasher substrates cannot achieve the vibration and noise damping as required for dishwashers and obtained with the present invention.

Moreover, the invention, and in particular the embodiments having a dense polyurethane layer directly applied onto the substrate, provides the insulation structure with a sealing effect that is not obtained by known solutions; of course, sealing is an important factor for dishwashers.

Non-limiting embodiments of the present invention will be described by way of example with reference to the accompanying drawings, in which:

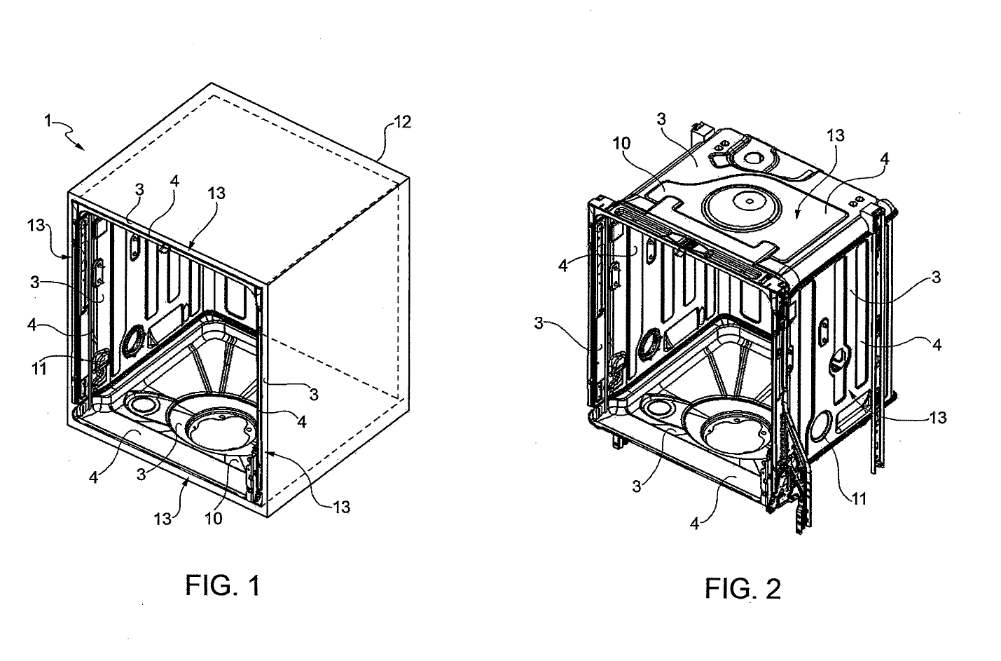

FIG. 1 is a schematic view of an insulated component of a dishwasher, specifically a dishwasher tub, according to the invention;

FIG. 2 is a schematic view of a base body of the dishwasher tub of FIG. 1;

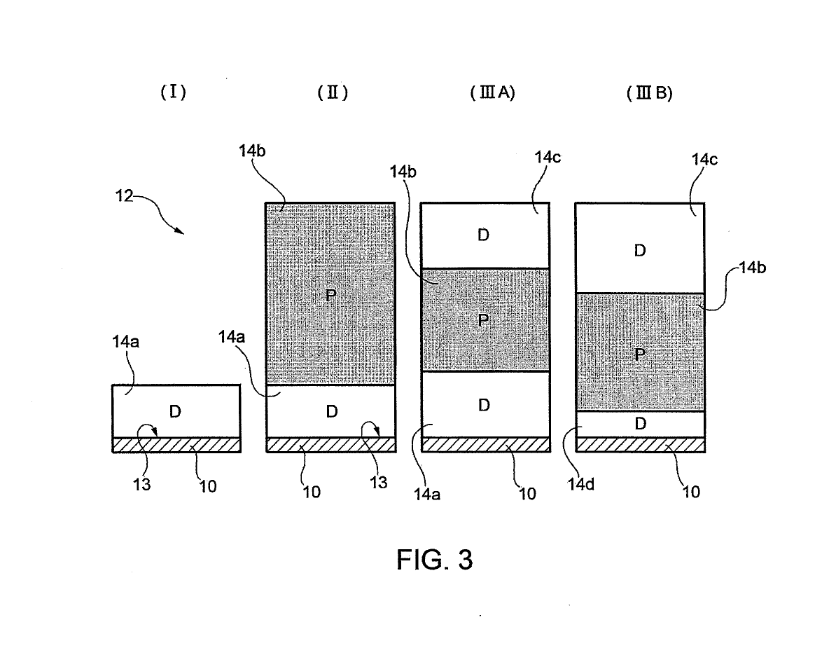

FIG. 3 is a schematic sectional view of a detail of a component according to several embodiments of the invention;

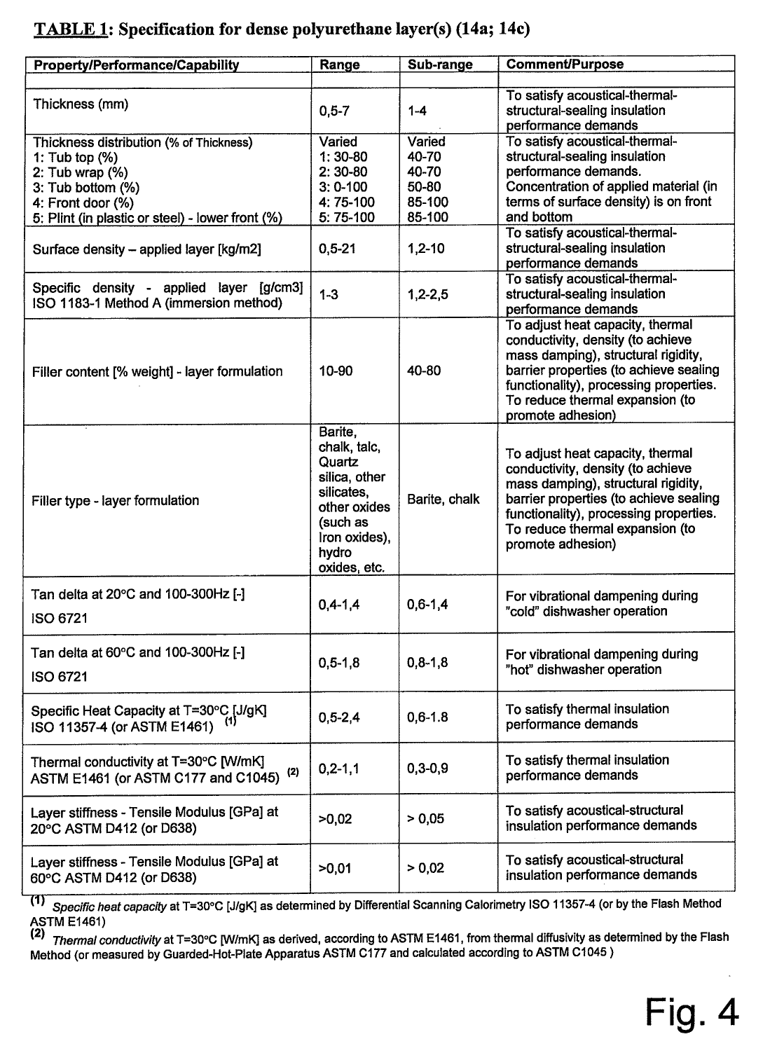

FIGS. 4-6 contain Tables providing details of the layers used in the embodiments of FIG. 3;

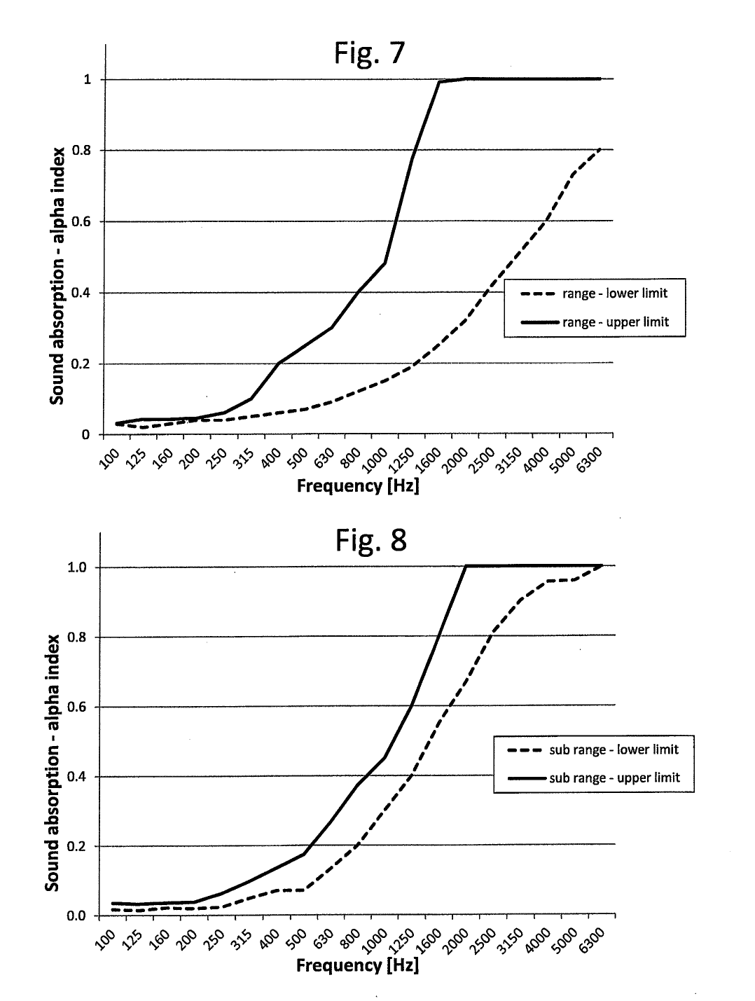

FIGS. 7-10 shows curves of the sound absorption α-coefficient and the noise transmission loss featured by some embodiments of the invention;

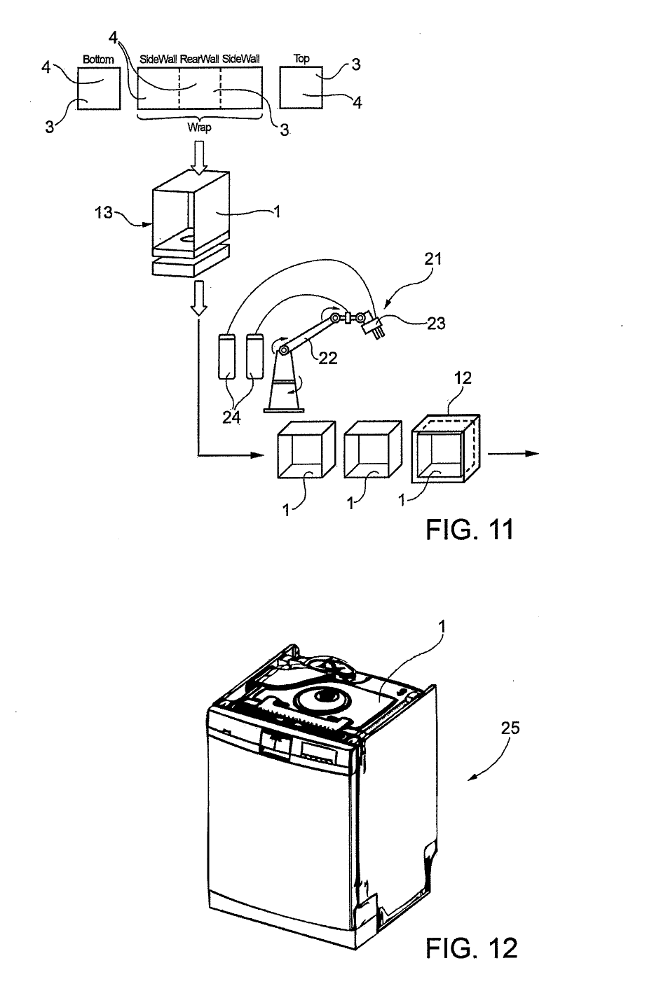

FIG. 11 is a schematic view of the method of the invention for manufacturing the component of FIG. 1;

FIG. 12 is a schematic view of a household appliance, in particular a dishwasher, comprising the insulated component of FIG. 1.

Number 1 in FIG. 1 indicates an insulated component 1 of a household appliance, in particular a tub of a dishwasher.

Components that are advantageously manufactured according to the invention are steel and plastic tubs/housings/washing chambers, steel and plastic innerdoors, bases and plinths (lower doors), parts thereof.

In the example of FIG. 1, the component (tub) 1 is formed by parts 3; in particular, the parts 3 include metal (steel) sheets 4 defining respective walls of the tub and assembled together to form the tub.

Preferably, three sheets 4 are connected to one another to form a single piece or wrap that, after folding, defines three side walls of the tub, while the top and bottom walls are defined by respective further sheets 4.

As an alternative, the component 1 has a body made of a plastic polymer material.

In any case, the component 1 comprises a substrate 10, defining a base body 11 having the basic shape of the component 1, and an insulation structure 12, applied onto an external surface 13 of the substrate 10.

FIG. 2 shows in greater details an example of a base body 11 (i.e. a substrate 10), and specifically a base body 11 of a dishwasher tub, to be provided with the insulation structure 12. The base body 11, as already described, is formed by parts 3, for example sheets 4 defining respective walls of the tub.

The insulation structure 12 comprises one or more layers 14 made of a sprayable filled polyurethane material that has been applied onto the surface 13 by a spraying process.

FIG. 3 shows different embodiments of the insulation structure 12.

In one embodiment of the invention, the insulation structure 12 consists of a single layer 14, while in other embodiments the insulation structure 12 is a multilayered structure comprising a plurality of layers 14.

The insulation structure 12 includes at least one elastomeric dense polyurethane layer 14, i.e. a layer made of an elastomeric polyurethane material having a specific density comprised between about 1 and 3 g/cm³. Because of this specific density, the dense layer can be considered as not foamed (i.e. not porous). Preferably, such an elastomeric dense polyurethane layer contains filler(s). Layers made of dense polyurethane material are identified by “D” in FIG. 3. Advantageously, a dense polyurethane layer is directly applied onto the substrate 10 (i.e. in contact with the surface 13 of the substrate 10).

According to the present invention, the properties of the different layers, including density, damping, specific heat capacity, thermal conductivity and stiffness, can be uniform o variable within the layer. If the properties are variable, the variation can be continuous or discontinuous (i.e., step-like) along a direction perpendicular to the surface of the component, with values always contained in the ranges indicated above, in order to optimize the overall layer performances. Therefore, in particular, the dense layer applied onto the surface 13 of the component 10 can have uniform or non-uniform characteristics in the thickness direction.

An example of continuous layer properties variation within the reported ranges that has showed a good overall performance improvement consists in a linear damping level variation starting from maximum damping value on the surface applied to the component to the lowest damping value on the external surface, but with maximum stiffness tensile modulus value on the external surface. Similar results can be achieved with a non-linear (for example according to a second order formula) of the properties variation along the thickness.

The Applicant has found that also a discontinuous variation of the properties within the reported ranges in the layer thickness can improve the overall layer performances. This can be achieved for example by making two or more sub-layers with different properties. The case of a layer “D” consisting of sub-layers with different properties renders it possible to generate a desirable material response over broader conditions. In particular, it is possible to apply a layer “D” consisting of two or more sub-layers with different viscoelastic properties in order to reach good vibrational damping, in terms of high loss factor, over the complete temperature range of interest for dishwasher operation, i.e. from “cold” condition to “hot” condition. Viscoelastic materials exhibit good vibrational damping (in terms of high loss factor) when oscillated in frequency-temperature conditions that bring the material close to its transition temperature. For conditions of relevance for dishwasher, most material solutions are limited to having one transition of practical importance for vibrational damping. This is a key defect, discovered by the Applicant, of solutions based on common material and of solutions based on cited prior art applicant (this defect or drawback is described also in other parts of this text). For these solutions, there are only two industrially feasible options at hand: either to compromise one condition in order to satisfy the other, or to compromise both conditions to satisfy overall performance. To overcome this problem, the layer “D” can be applied as two (or more) dense sub-layers, each sub-layer having a different transition temperature, in order to achieve high loss factor over a greater range of conditions. In one non-limiting example, the layer “D” consists of a first sub-layer with a transition temperature in the range of −10° C. to 20° C. (to achieve high damping in the lower temperature range of dishwasher operation, incl. “cold” condition) and a second sub-layer with transition temperature in the range of 50° C. to 80° C. (to achieve high damping in the higher temperature range of dishwasher operation, incl. “hot” condition). This example is only indicative because, for polyurethanes of relevance for the scope of the present invention, these transitions are influenced by kinetics and subsequently the transition temperature varies with frequencies (transition temperature is shifted to higher temperatures for higher frequencies).

In some embodiments of the present invention, the insulation structure 12 includes also at least one porous foamed polyurethane layer 14, i.e. a layer made of a polyurethane material that is porous being foamed. Advantageously, such porous foamed polyurethane layer is a flexible layer. Layers made of porous foamed polyurethane material are identified by “P” in FIG. 3.

If the insulation structure 12 is a multilayered structure, then the structure 12 includes an elastomeric dense polyurethane layer applied onto (i.e. contacting) the surface 13 of the substrate 10, a flexible porous foam polyurethane layer applied onto the elastomeric dense polyurethane layer, and possibly other elastomeric dense polyurethane layers and flexible porous foam polyurethane layers. The dense (“D”) and porous (“P”) layers are applied so as to alternate with each other in a sequence D-P-D-P . . . . The dense polyurethane layers have a specific density greater than the porous polyurethane layers. Moreover, the dense polyurethane layer applied onto the surface 13 has a thickness lower than the porous polyurethane layer applied onto it.

In embodiment (I) of FIG. 3, the insulation structure 12 consists of a single layer 14a made of elastomeric dense polyurethane material applied onto the surface 13 of the substrate 10.

In embodiment (II), the insulation structure 12 is a two-layer structure comprising an elastomeric dense polyurethane material layer 14a, directly applied onto the surface 13 of the substrate 10 (that is, in contact with the substrate 10), and a porous (foamed) polyurethane material layer 14b applied onto the dense layer 14a.

In embodiment (IIIA), the insulation structure 12 is a three-layer structure comprising: a first elastomeric dense polyurethane material layer 14a, directly applied onto the surface 13 of the substrate 10; a porous (foamed) polyurethane material layer 14b applied onto the first dense layer 14a; and a second elastomeric dense polyurethane material layer 14c applied onto the foamed layer 14b.

The two dense polyurethane layers 14a, 14c can have substantially the same density and/or thickness, or differ from each other as for density and/or thickness. Moreover, they can have same transition temperature or, advantageously, have different transition temperatures (or have several and different transition temperatures). In embodiment (IIIB), which is a variation of embodiment (IIIA), for example, the insulation structure 12 is a three-layer structure comprising: a first elastomeric dense polyurethane material layer 14d, directly applied onto the surface 13 of the substrate 10; a porous (foamed) polyurethane material layer 14b applied onto the first dense layer 14d; and a second elastomeric dense polyurethane material layer 14c applied onto the foamed layer 14b; wherein the first dense polyurethane layer 14d has a density and/or a thickness lower than the second elastomeric dense polyurethane material layer 14c.

All the embodiments (I), (II), (IIIA) and (IIIB) fulfill the requirements on tub stiffening, manufacturing and dishwasher life-time retained insulation performance.

In particular, embodiments (IIIA) and (IIIB) are especially preferred for having technical performance, such as structural stiffening effect and product specification, fulfilling both acoustical and energy consumption requirements.

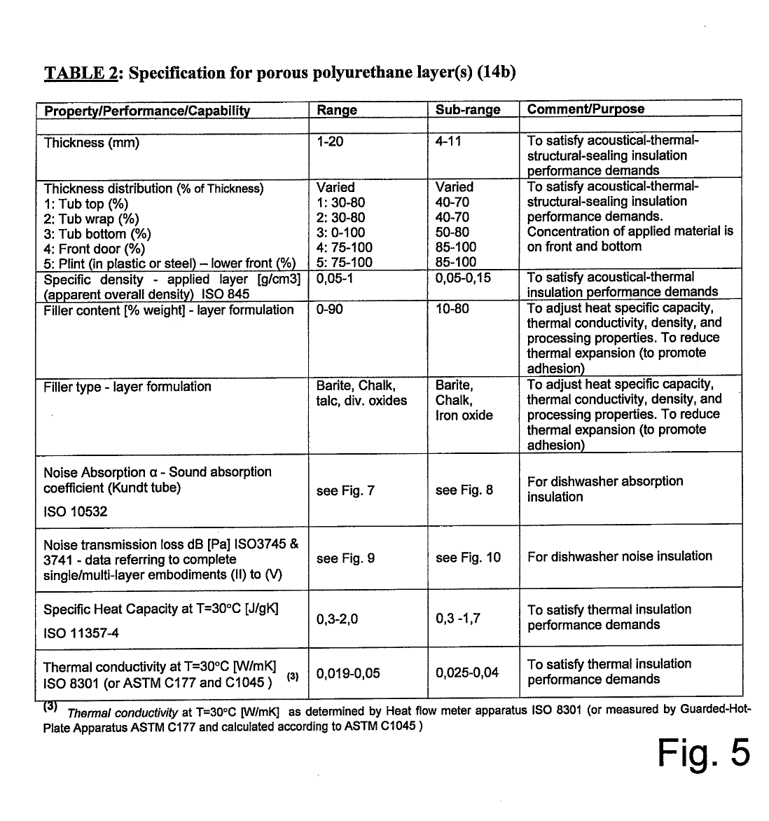

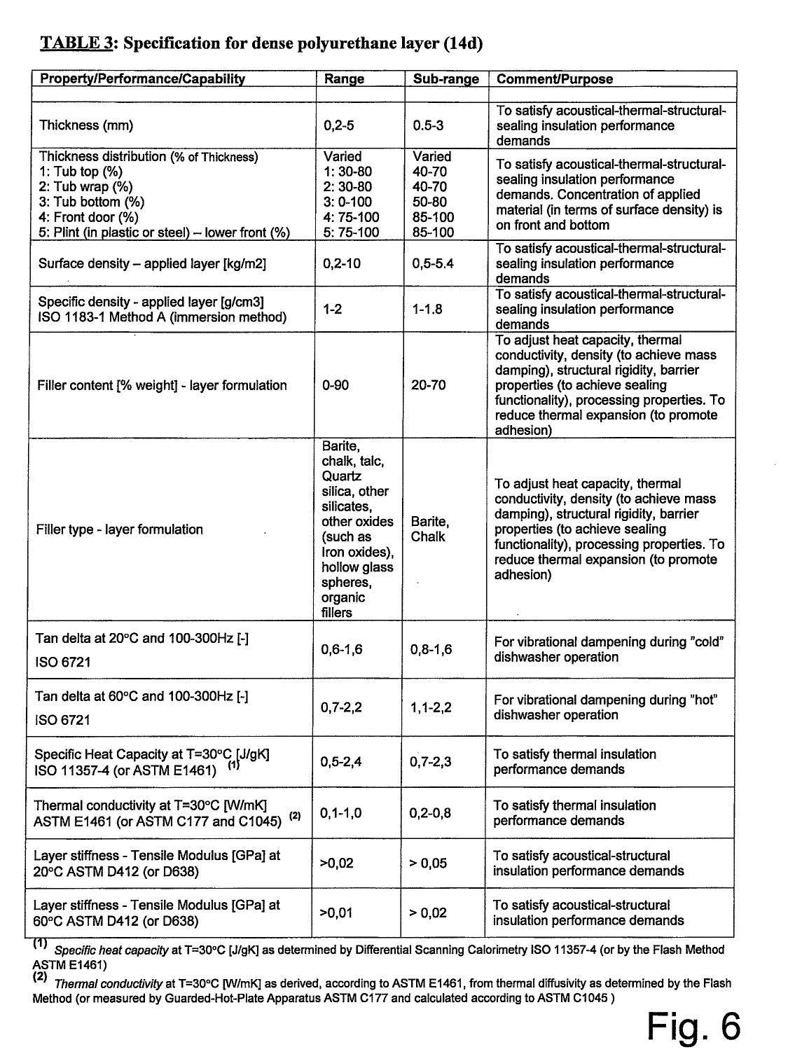

Preferred details of each layer in the embodiments (I) to (IIB) are provided in Tables 1 to 3 (FIGS. 4 to 6): Table 1 in FIG. 4 discloses details of the dense polyurethane layers 14a and 14c; Table 2 in FIG. 5 discloses details of the porous layers 14b; and Table 3 in FIG. 6 contains details of the dense polyurethane layer 14d. For each property, the possible ranges of values are given, as well as preferred sub-ranges.

Parameter values provided in Tables 1-3 specifically refer to a steel substrate; the substrate can however be made of a different metal or plastic (polymer) material; the parameters can be accordingly adjusted to fit to the different substrate.

The Specific Heat Capacity in Tables 1 and 3 is as determined by Differential Scanning Calorimetry ISO 11357-4 (or by the Flash Method ASTM E1461). The Specific Heat Capacity in Table 2 is as determined by Differential Scanning Calorimetry ISO 11357-4.

The Thermal conductivity in Tables 1 and 3 is as derived, according to ASTM E1461, from thermal diffusivity as determined by the Flash Method (or measured by Guarded-Hot-Plate Apparatus ASTM C177 and calculated according to ASTM C1045). The Thermal conductivity in Table 2 is as determined by Heat flow meter apparatus ISO 8301 (or measured by Guarded-Hot-Plate Apparatus ASTM C177 and calculated accord. to ASTM C1045).

As already mentioned, an important characteristic of the material is the damping performance, which is measured in terms of “loss factor” or “tan delta”, as defined in the standard ISO 6721, in particular ISO 6721-1. For the purposes of the present invention, with “loss factor” or “tan delta” it is intended the ratio between the loss modulus and the storage modulus where “delta” is the phase angle between stress and strain. The loss factor is expressed as a dimensionless number [−], being equivalent to [Pa/Pa]. The loss factor “tan delta” is commonly used as a measure of the damping in a viscoelastic system.

The loss factor tabled value ranges given for the layer specifications in Tables 1 to 3 (FIGS. 4 to 6) refer, where applicable, to the shear test method (as described in ISO 6721-6), flexural test method (as described in ISO 6721-5) or torsion test method (as described in ISO 6721-7). The test(s) is (are) performed on test specimens prepared inline with recommendations given by relevant ISO 6721 test method part. It is important to select a specimen size consistent with the modulus of the material under test and capabilities of the measuring apparatus. It is even more important to select a test method consistent with the modulus of the material under test and the loss factor determination capabilities (frequency) of the measuring apparatus, inline with limitations outlined in ISO 6721-1 and in respective test method part of ISO 6721. The test specimens are preferably prepared from samples taken from the material as applied on the appliance (or prepared by a process method that corresponds to the final method used to produce the insulated component). The test is performed using a dynamic strain amplitude lower than the strain limit for linear viscoelastic behaviour of the tested material (that is detected with same instrumental setup). ISO 6721-1 provides a general description on how to define and to detect the linear viscoelastic strain limit. Specifically, in the context of the present invention and the loss factor tabled value ranges, a pre-test is carried out to detect the linear viscoelastic strain limit (i.e. the limit for linear behaviour). This pre-test(s) is carried out at 20° C. with the same test method and with the same frequency as used for the loss factor determination, i.e. isothermal test at single frequency. The scope of the pre-test(s) is to gradually increase the dynamic strain with the objective to identify the dynamic strain limit for linear behaviour (from plotting dynamic stress, or alternatively logarithmic storage modulus, as a function of dynamic strain). The linear viscoelastic strain limit is then defined as the dynamic strain where the dynamic stress response, as a function of dynamic strain, is no more linear.

Four loss factor tests are required to understand if a material fulfils the loss factor selection criteria, in terms of the value ranges of tan delta at 100-300 Hz, given in Table 1 (FIG. 4) and Table 3 (FIG. 6). Each loss factor test is performed as a temperature sweep to cover the two temperatures of interest in Table 1 and Table 3 (20° C. and 60° C.). The temperature sweep is performed with 2° C./min constant heating rate and an initial temperature of 0° C. and a final temperature of 80° C. Test 1 is performed at 300 Hz and the preferred test method for this test, when applicable, is shear (as described by ISO 6721-6). Test 2 is performed at 200 Hz and the preferred test method, when applicable, is shear (as described by ISO 6721-6). Test 3 is performed at 100 Hz and the preferred test method, when applicable, is shear (as described by ISO 6721-6). Test 4 is performed at 70 Hz and the preferred test method, when applicable, is torsion (as described by ISO 6721-7). If the preferred test method is not applicable (due to limitations given by material and test specimen characteristics to fulfil the conditions described in ISO 6721-1 and in the respective test method part of ISO 6721), the second preferred test method for Test 1-4 is the flexural test method (as described in ISO 6721-5 and as applied inline with the applicability instructions and recommendations given in ISO 6721-1 and ISO 6721-5).

To fulfil the material loss factor specification given in Table 1 and Table 3, i.e. the tan delta at the temperatures of interest 20° C. and 60° C. and at 100-300 Hz, it is required that at least one of the four tests (Test 1 to 4) records the loss factor values within the indicated ranges.

In all the embodiments, the insulation structure 12 comprises at least one layer made of one or more sprayable filled polyurethane materials, in particular an elastomeric dense polyurethane material, having a tan delta at 20° C. and at 100-300 Hz according to ISO 6721 comprised between about 0.4 and 1.6 and a tan delta at 60° C. and at 100-300 Hz according to ISO 6721 comprised between about 0.5 and 2.2.

Preferably, the tan delta at 20° C. and at 100-300 Hz according to ISO 6721 is comprised between about 0.6 and 1.6.

Preferably, the tan delta at 60° C. and at 100-300 Hz according to ISO 6721 is comprised between about 0.8 and 2.2.

Moreover, preferably the dense layer has a surface density comprised between about 0.2 and 21 kg/m², more preferably comprised between about 0.5 and 10 kg/m².

The dense layer has preferably a thickness comprised between about 0.2 and 7 mm, more preferably comprised between about 0.5 and 4 mm.

A preferred range of specific density for the dense layer is between about 1 and 3 g/cm³.

The specific heat capacity at 30° C. of the dense layer is preferably comprised between about 0.5 and 2.4 J/gK.

Of the mentioned properties, the specific density and the tan delta (at the two different temperatures) are those mostly characterizing the dense layer.

FIGS. 7-8 show the sound absorption α-coefficient (Kundt tube) according to ISO 10532 of the porous layers of Table 2; the porous layers according to the invention are made so as to have an α-coefficient preferably included between the curves of FIG. 7 and, more preferably, between the curves of FIG. 8. In FIG. 7, the continuous line and the discontinuous line represent respectively the upper limit and the lower limit of the preferred range of values of the α-coefficient (or “alfa index”), and in FIG. 8 the same kind of lines represent respectively the upper limit and the lower limit of a preferred sub-range of values of the α-coefficient.

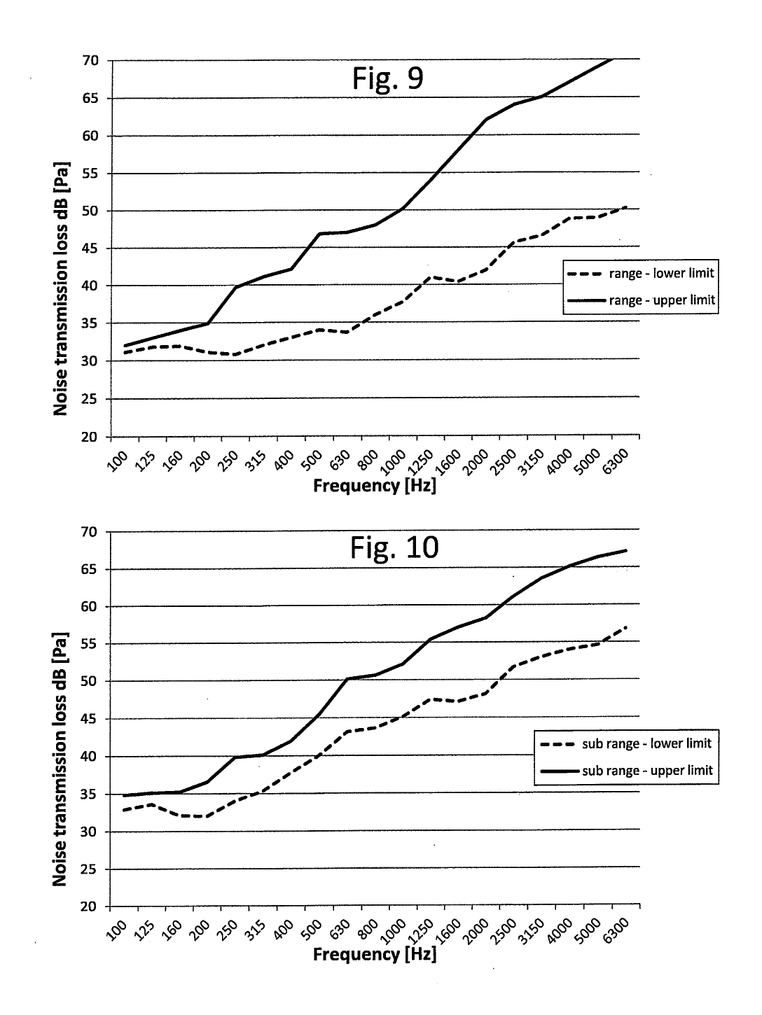

The porous layers combined with dense layers according to embodiments from (II) to (IIIB) are also made so as to perform a noise transmission loss (according to ISO 3745 and 3741) preferably included between the curves of FIG. 9 and, more preferably, between the curves of FIG. 10. Again, the continuous and discontinuous lines represent respectively the upper and lower limit of the preferred range (FIG. 9) and sub-range (FIG. 10) of values of the noise transmission loss.

Polyurethanes are polymers obtained by addition polymerization mechanism between molecules having two or more hydroxyl groups (—OH) and molecules having two or more isocyanate groups (—NCO). In the presence of catalysts, the exothermal reaction occurs at room temperature and polymers having a structure with urethane groups are formed. The isocyanates react readily with all kinds of molecules having hydroxyl groups (including water).

With respect to formulation, polyurethane consists of two main components: an isocyanate (often referred to as A-component) and a polyol (often referred to as B-component).

Isocyanates may have different structures (aromatic, aliphatic, cyclo-aliphatic) and have properties and behaviour that depend on functionality groups, molecular weight and chemical structure.

Polyols can be roughly divided into two main families: polyethers and polyesters (either aliphatic or aromatic). Their behaviour depends on functionality groups and molecular weight. It is common to use mixtures of different polyols to reach targeted performances in terms of process-ability, properties and cost. Polyesthers tend to be generally more sensitive to hydrolysis and therefore polyethers are generally better suited for applications with wet service conditions. Specific end performances are reached by selection of polyisocyanates and polyols mixtures.

There exist various types of isocyanates that could be used. For industrial reasons, preferred type is polymeric-methylen-di-phenil-isocyanate (PMDI), or alternatively prepolymers of isocyanate and polyols.

For the present invention, formulation and thickness of the foam layer(s) have to be adjusted to obtain the targeted sound absorption and thermal insulation. Suitable low density flexible foams are made by the simultaneous reaction of a diisocyanate with a hydroxyl-group-ended polyether (or polyesther) and with water. The carbon dioxide produced by the water/isocyanate reaction is contained within the polymerizing material which expands to form foam.

For the present invention, the function of the elastomeric heavy (dense) layer(s) is to provide highest possible damping effect with minimum thermal mass. The effective applied layer mass can be adjusted by changing the density of the material and/or the thickness of the layer. Fillers like calcium carbonate or barium sulfate can be used to reach a good cost-to-performance ratio and to vary thermal properties (for instance, to reduce the specific heat capacity). The total damping effect is accomplished by the contribution of mass damping and viscous damping; the importance of each contribution depends on specific end-application requirements.

Ways to produce a polyurethane sandwich comprising multilayer structures of heavy layer(s) and flexible foam layer(s) are generally known. Generally, adhesion between layers can be achieved through balancing process so that each layer applied is given sufficient time to pass its gel point (the point at which cross-linking between binder, the A-component, and resin, the B-component, has generated a sufficient long molecular network structure to be no longer liquid) but still exhibit tackiness.

With reference to FIG. 11, the component 1 is manufactured by a method comprising mainly the following steps:
providing the parts 3 of the component 1;
assembling the parts 3 to form the component 1;
applying by a spray process the insulation structure 12 onto the surface 13 of the component 1.

If the insulation structure 12 is a multi-layered structure comprising a plurality of layers 14, all layers 14 are applied by the spray process in sequence, in respective spraying steps.

The insulation structure 12 is applied by a spray process, which combines ease of application and relatively limited investments, and also allows good control on thickness and surface quality even in presence of quite complex shapes. Both foams and compact materials can be applied by spraying.

The self-adhesive nature of sprayed polyurethane materials allows simplifying pre-treatment step of the substrate, further contributing to reduce investments. Moreover, strong adhesion enhances structural properties of the resulted sandwich structure, offering opportunities to reduce substrate thickness.

The chemical components are mixed and sprayed using commercially available machines, provided with pumps and spray guns. Total out-put can be adjusted from 10 kg/minute up to 50 kg/minute, according to the specific process requirements.

Automated arms drive movements of spray guns, in order to keep constant the distance from the substrate surface and so granting even thickness distribution, following also complex shapes.

FIG. 11 shows a setup of a polyurethane spray application line used according to the invention.

Basically, after the steps of providing the parts 3 of the component 1 and assembling the parts 3 to form the component 1, the insulation structure 12 is sprayed onto the component 1 by a spray gun 21, mounted on an automated arms device 22; the spray gun 21 is provided with a high pressure mixing head 23, connected to raw materials tanks 24 that contain the components of the polyurethane materials to be sprayed, and specifically the polyol component and the isocyanate component. Preferably, the polyol is added with the filler before being supplied to the mixing head 23; the mixing head 23 receive both the polyol with the filler and the isocyanate, which reacts to form the polyurethane material having properties/formulation designed for of each layer 14.

It is important to notice that the spray process is performed on the whole substrate 10, i.e. on all the walls of the component 1, including the bottom wall; this is particularly important for manufacturing dishwasher tubs, since other known manufacturing method do not generally allow multi-layered insulation layers to be applied on the bottom wall of the tub.

Then, the component 1 is finished by usual additional operations. FIG. 12 shows a household appliance 25, in particular a dishwasher, comprising an insulated component 1 (tub) according to the invention.

Clearly, further changes may be made to the component and the manufacturing method described herein without, however, departing from the scope of the present invention as defined by the enclosed set of claims.

1. An insulated component of a household appliance, in particular of a dishwasher, comprising a substrate and an insulation structure applied onto a surface of the substrate, the insulation structure comprising one or more layers made of one or more sprayable filled polyurethane materials, wherein the one or more layers comprise a first layer made of elastomeric polyurethane material applied directly onto the surface of the component and having the following properties:
a specific density comprised between about 1 and 3 g/cm³;
a tan delta at 20° C. and at 100-300 Hz comprised between about 0.4 and 1.6; and
a tan delta at 60° C. and at 100-300 Hz comprised between about 0.5 and 2.2.

2. The insulated component according to claim 1, wherein said first layer has a tan delta at 20° C. and at 100-300 Hz comprised between about 0.6 and 1.6.

3. The insulated component according to claim 1, wherein said first layer has a tan delta at 60° C. and at 100-300 Hz comprised between about 0.8 and 2.2.

4. The insulated component according to claim 1, wherein said first layer has a surface density comprised between about 0.2 and 21 kg/m².

5. The insulated component according to claim 4, wherein said first layer has a surface density comprised between about 0.5 and 10 kg/m².

6. The insulated component according to claim 1, wherein said first layer has a thickness comprised between about 0.2 and 7 mm.

7. The insulated component according to claim 6, wherein said first layer has a thickness comprised between about 0.5 and 4 mm.

8. The insulated component according to claim 1, wherein said first layer has a specific density comprised between about 1 and 2.5 g/cm³.

9. The insulated component according to claim 1, wherein said first layer has a specific heat capacity at 30° C. comprised between about 0.6 and 2.3 J/gK.

10. The insulated component according to claim 1, wherein the insulation structure further comprises a second layer made of porous foamed polyurethane applied onto said first layer.

11. The insulated component according to claim 10, wherein the insulation structure comprises a third layer made of elastomeric polyurethane material applied onto the second layer and having a specific density comprised between about 1 and 3 g/cm³.

12. The insulated component according to claim 1, wherein the properties of the first layer vary along a direction perpendicular to the surface of the substrate.

13. The insulated component according to claim 1, wherein the component is one of a dishwasher tub, housing, washing chamber, door, base, plinth, or parts thereof.

14. A household appliance, in particular a dishwasher, comprising the insulated component according to claim 1.

15. A method for manufacturing an insulated component of a household appliance, in particular of a dishwasher, comprising the steps of:
providing a substrate defining a base body of the component;
applying by a spray process an insulation structure onto the surface of the component, the insulation structure comprising one or more layers applied by respective spraying steps and being made of one or more sprayable filled polyurethane materials, wherein said one or more layers comprise a layer made of elastomeric polyurethane material having the following properties:
a specific density comprised between about 1 and 3 g/cm³;
a tan delta at 20° C. and at 100-300 Hz comprised between about 0.4 and 1.6; and
a tan delta at 60° C. and at 100-300 Hz comprised between about 0.5 and 2.2.
